(19) United States
(12) Patent Application Publication
(10) Pub. No.: US 2011/0146292 A1
(43) Pub. Date: Jun. 23, 2011

(54) METHOD FOR STARTING A TURBOMACHINE

(75) Inventors: Matthew B. Grant, Greenville, SC (US); Joseph R. Law, Greer, SC (US)

(73) Assignee: General Electric Company

(21) Appl. No.: 12/646,101

(22) Filed: Dec. 23, 2009

(51) Int. Cl. F02C 9/26; F02C 7/26

(52) U.S. Cl. 60/778; 60/790

(57) ABSTRACT

Embodiments of the present invention employ a closed loop controls philosophy that actively determines the air-to-fuel ratio of turbomachine throughout the start-up process. This closed loop controls philosophy provides many benefits. This philosophy performs the ignition process while the turbomachine is operating at a purge speed and eliminates the associated coast down period. Reduces or eliminates the warm-up timer. The philosophy may also increase the acceleration rate of the turbomachine to the primary operating speed. These benefits may reduce the overall start-up time of the turbomachine.

Furthermore, by actively controlling the air-to-fuel ratios during the start-up processes, the turbomachine may be operated on a nearly optimal and repeatable schedule. These benefits may reduce thermal transients, possibly extending parts life; reduce variations in start-up times, and possibly increasing combustor margin.

This application is related to commonly-assigned U.S. patent application Ser. No. 12/331,824 [GE Docket 230465-2], filed Dec. 10, 2008.

### BACKGROUND OF THE INVENTION

The present invention relates generally to the operation of a turbomachine, and more particularly, to a method of reducing the start-up time of the turbomachine.

“Fast Start” may be considered an operating mode requiring a turbomachine to export a load, capable of emissions complaint operation, within a certain time after an operator initiates a start of that turbomachine. Fluctuating energy demand is a major factor in determining when the turbomachine operates. Turbomachines are commonly idled until sufficient demand requires operation. When demand requires operation, the turbomachine performs a start-up process before exporting the desired energy (electricity, mechanical torque, steam, and the like).

Peaking or simple cycle plants can execute Fast Starts and are then replaced by efficient generation over a longer period. Moreover, the current assignee of the application, General Electric Company, has a portfolio of combined cycle (CC) power plants (CCPP), such as, but not limited to, those disclosed in US27113562A1, entitled “Method and Apparatus for Starting Up Combined Cycle Power Systems”. In addition, U.S. Pat. No. 4,207,864, entitled “Damper”; U.S. Pat. No. 4,208,882, entitled “Startup Attemperator”; U.S. Pat. No. 4,598,551, entitled “Apparatus and Method for Controlling Steam Turbine Operating Conditions During Starting and Loading”. Also, U.S. Pat. No. 5,361,585, entitled “Steam Turbine Split Forward Flow”; U.S. Pat. No. 5,412,936, entitled “Method of Effecting Start-up of a Cold Steam Turbine System in a Combined Cycle Plant”; U.S. Pat. No. 6,626,635, entitled “System for Controlling Clearance Between Blade Tips and a Surrounding Casing in Rotating Machinery”. Reference to these commonly assigned patents and patent applications can provide further insight into the scope of the Fast Start technology and the subject matter herein.

The start-up process of some known turbomachines typically involves a plurality modes occurring at different operating speeds. These modes include, but are not limited to: a purge, an ignition, a warm-up, and acceleration to a primary operating speed. This start-up process requires a coast down period from the purge speed to an ignition speed. This coast down period typically requires several minutes to complete. Fast Start technology requires turbomachines to quickly start and generate power.

Therefore, there is a desire for an improved method of starting a gas turbine. The method should reduce the start-up time. This method should also reduce or eliminate the time associated with the coast down and warm-up periods. This method should also reduce the time of accelerating the turbomachine to a primary operating speed, such as, but not limiting of, full-speed-no-load (FSNL).

### BRIEF DESCRIPTION OF THE INVENTION

In an embodiment of the present invention, a method of starting a turbomachine, the method comprising: providing a turbomachine comprising: a compressor section, a fuel system, and a combustion system; selecting a purge speed for the turbomachine; and accelerating the turbomachine to the purge speed; wherein the step of selecting the purge speed allows for reducing a start-up time of the turbomachine.

An alternate embodiment of the present invention provides a method of starting a turbomachine, the method comprising: providing a turbomachine comprising: a compressor section, a fuel system, and a combustion system; selecting a purge speed for the turbomachine; accelerating the turbomachine to the purge speed; determining whether a purge cycle is complete; and selecting an acceleration rate for an acceleration process of the turbomachine; wherein the step of selecting the purge speed allows for reducing a start-up time of the turbomachine, increasing the possibility of the turbomachine meeting a requirement of a Fast Start operation.

Another alternate embodiment of the present invention provides a system configured for starting a turbomachine, the system comprising: a turbomachine comprising: a compressor section, a fuel system, and a combustion system; and a control system configured for controlling a starting process of the turbomachine, wherein the control system performs the steps of: selecting a purge speed for the turbomachine; accelerating the turbomachine to the purge speed; determining an ignition air-to-fuel ratio for an ignition process associated with the combustion system; utilizing the ignition air-to-fuel ratio while performing the ignition process; selecting an acceleration rate for an acceleration process of the turbomachine; determining an acceleration air-to-fuel ratio for the acceleration process of the turbomachine; and utilizing the acceleration air-to-fuel ratio while accelerating the turbomachine to an operating speed.

### BRIEF DESCRIPTION OF THE DRAWINGS

FIG. 1 is a schematic illustrating an environment within which a known method of starting a turbomachine operates.

FIG. 2 is a schematic illustrating an environment within which an embodiment of the present invention may operate.

FIG. 3 is a block diagram illustrating algorithms of a control system used to start-up a turbomachine, in accordance with an embodiment of the present invention.

FIGS. 4A, 4B, collectively FIG. 4, are flowcharts illustrating a method of starting a turbomachine, in accordance with an embodiment of the present invention.

### DETAILED DESCRIPTION OF THE INVENTION

As discussed, “Fast Start” may be considered an operating mode of a powerplant machine. This mode generally requires the powerplant machine to export a load, while operating in emissions compliance, within a certain time after a start of that powerplant machine is initiated. As used herein, the term Fast Start is intended to include all such modes and equivalents thereof within the scope of this invention.

The present invention has the technical effect of reducing the start-up time associated with starting a turbomachine. An embodiment of the present invention provides a method of starting a turbomachine, such as, but not limiting of, a gas turbine set to operate in a Fast Start mode. The gas turbine may include, but is not limited to, a heavy-duty gas turbine, an aero-derivative gas turbine, and the like. An embodiment of the method of the present invention provides a new philosophy for starting a turbomachine. Although embodiments of the present invention are described in relation to a gas turbine, application of the present invention is not limited to a gas turbine. Embodiments of the present invention may be applied to other industrial machines that may burn an ingested air with at least one fuel, not described herein.

Detailed example embodiments are disclosed herein. However, specific structural and functional details disclosed herein are merely representative for purposes of describing example embodiments. Example embodiments may, however, be embodied in many alternate forms, and should not be construed as limited to only the embodiments set forth herein.

Accordingly, while example embodiments are capable of various modifications and alternative forms, embodiments thereof are illustrated by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any, and all, combinations of one or more of the associated listed items.

The terminology used herein is for describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted might occur out of the order noted in the FIGS. Two successive FIGS., for example, may be executed substantially concurrently or may sometimes be executed in the reverse order, depending upon the functionality/operations involved.

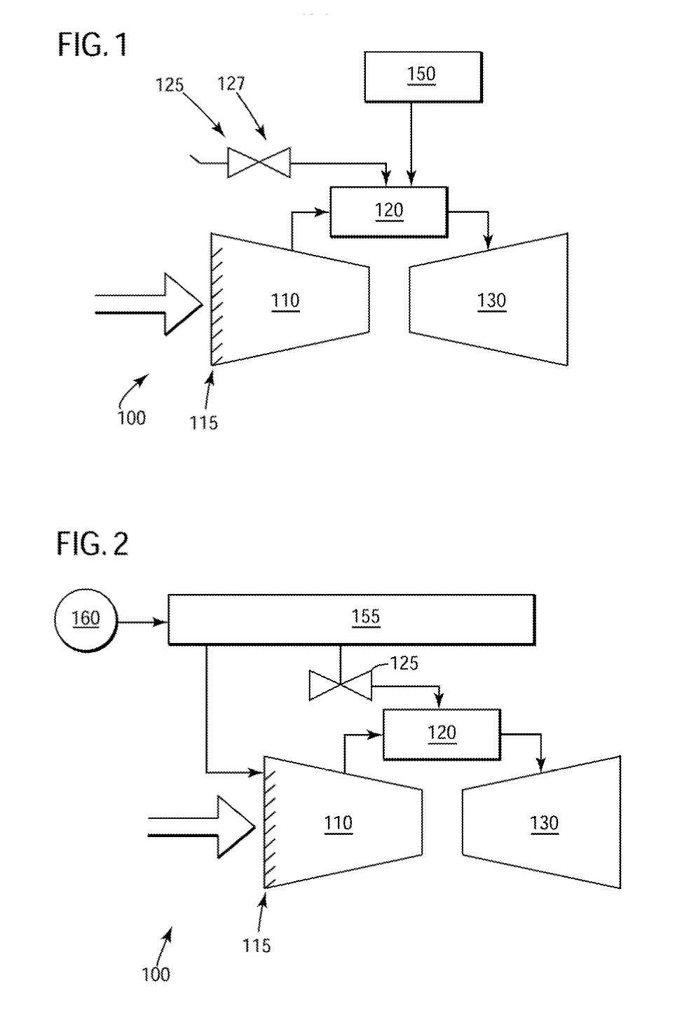

Referring now to the FIGS., where the various numbers represent like parts throughout the several views. FIG. 1 is a schematic illustrating an environment within which a known method of starting a turbomachine operates. In FIG. 1, a turbomachine 100, in the form of a gas turbine, includes: a compressor section 110; a combustion system 120; a fuel supply system 125; a turbine section 130; and a turbine control system 150. The combustion system 120 may receive a fuel from a fuel circuit 127 of the fuel system 125. Embodiments of the fuel system 125 may comprise multiple fuel circuits 127. Here, the multiple fuel circuits may include at least one of: a gas fuel circuit; a liquid fuel circuit; or an IGCC circuit, which is configured for delivering a mixed or synthetic gas fuel. Embodiments of the present invention may be applied to a gas turbine 100 with a fuel system 125 comprising either single or multiple fuel circuits 127.

Generally, the compressor section 110 includes a plurality of inlet guide vanes (IGVs) 115 and a plurality of rotating blades and stationary vanes structured to compress an ingested air, illustrated by the large arrow in FIG. 1. Within the combustion system 120, the compressed air and fuel are mixed, ignited, and create a working fluid.

The working fluid generally proceeds downstream from the combustion system 120 to the turbine section 130. The turbine section 130 includes a plurality of rotating and stationary components (neither of which are illustrated) that convert the working fluid to a mechanical torque, which may be used to drive a load.

Operationally, known methods of starting-up the gas turbine 100 performs the following steps. The control system 150 accelerates the gas turbine 100 to a predefined purge speed. Then, the control system maintains the purge speed until a predefined timer is complete. The length of this timer is previously determined, factory set, or the like. This timer serves to ensure that sufficient airflow passes through an exhaust system (not illustrated), after which the purging process is complete.

After the purge is complete, the control system 150 decelerates the gas turbine 100 to a predefined ignition speed. At this ignition speed, a valve position, of the combustion system 120, is modulated to a predefined position for ignition fuel flow, controlled under an open loop fuel flow philosophy. After ignition and a pre-defined warm-up timer expires, the control system 150 accelerates the gas turbine 100 to a primary operating speed, such as, but not limiting of, FSNL, using an open loop fuel and air schedules. These schedules are fixed and typically do not account for changes in gas turbine 100 performance or inlet conditions, resulting in a large variation in start up times.

As will be appreciated, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit”, “module,” or “system”. Furthermore, the present invention may take the form of a computer program product on a computer-usable storage medium having computer-usable program code embodied in the medium. As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

Computer program code for carrying out operations of the present invention may be written in an object oriented programming language such as Java7, Smalltalk or C++, or the like. However, the computer program code for carrying out operations of the present invention may also be written in conventional procedural programming languages, such as the “C” programming language, or a similar language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a public purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory. These instructions can direct a computer or other programmable data processing apparatus to function in a particular manner. The such that the instructions stored in the computer-readable memory produce an article of manufacture including instruction means which implement the function/act specified in the flowchart and/or block diagram block or blocks. The computer program instructions may also be loaded onto a computer or other programmable data processing apparatus. These instructions may cause a series of operational steps to be performed on the computer or other programmable apparatus to produce a computer implemented process. Here, the instructions, which execute on the computer or other programmable apparatus, provide steps for implementing the functions/acts specified in the flowchart and/or block diagram blocks.

Embodiments of the present invention employ a closed loop controls philosophy, which actively determines the air-to-fuel ratio of the gas turbine 100 throughout the start-up process. This closed loop controls philosophy may provide the following benefits. Performing the ignition process while the gas turbine 100 is operating at the purge speed; eliminates the aforementioned coast down period. Reducing or eliminating the warm-up timer. Increasing the acceleration rate of the gas turbine 100 to the primary operating speed. These benefits may reduce the overall start-up time of the gas turbine 100. Furthermore, by actively controlling the air-to-fuel ratios during the start-up processes, the gas turbine 100 may be operated on a nearly optimal and repeatable schedule. These benefits may reduce thermal transients, possibly extending parts life; reduce variations in start-up times, and possibly increasing combustor margin.

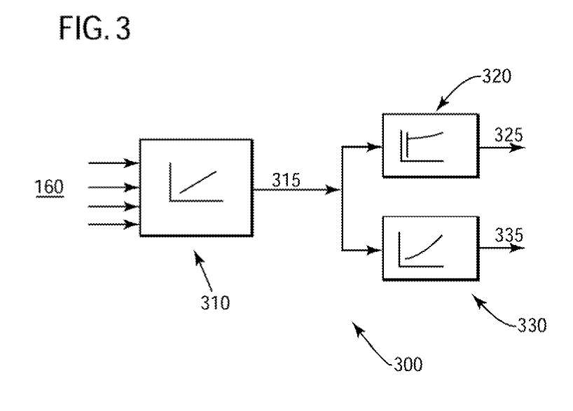

Referring again to the Figures, FIG. 2 is a schematic illustrating an environment within which an embodiment of the present invention may operate. The majority of the components of the gas turbine 100 discussed with FIG. 1, are the same in FIG. 2. The discussion of FIG. 2 focuses on an embodiment of the present invention applied to the gas turbine 100. An embodiment of the present invention may provide a modified control system 155.

The control system 155 may be configured with an algorithm that applies an embodiment of the present invention to the gas turbine 100. This algorithm may determine the air-to-fuel ratio in real time. Here, the control system 155 may receive operating data 160 corresponding to the air ingested by the compressor 110 and the fuel delivered by the fuel supply system 125. This operating data 160 may also correspond to the operating characteristics of the compressor 110 and the fuel supply system 125.

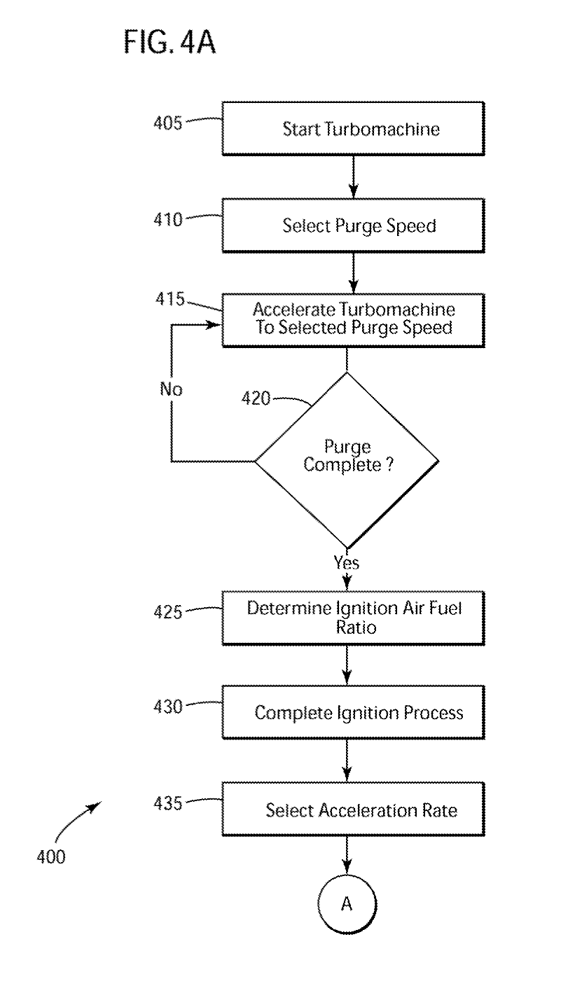

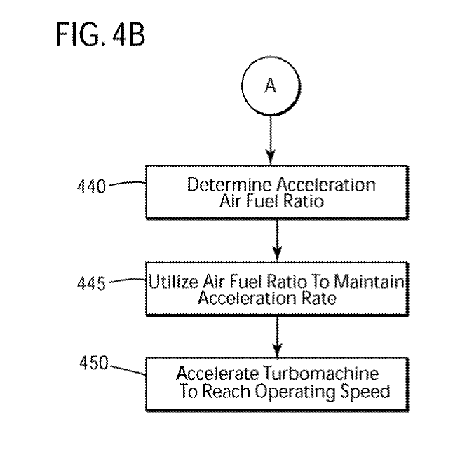

After receiving the operating data, the control system may determine the air-to-fuel ratio for the ignition mode and the acceleration mode of the start-up process. Next, the control system 155 may modulate the IGVs 115 and/or a valve of the fuel system 125, apportioning the air and/or fuel required to achieve or maintain the optimum air-to-fuel ratio for the specific start-up mode. FIGS. 3 and 4 discuss this process in further detail.

FIG. 3 is a block diagram 300 illustrating algorithms of a control system 155 used to start-up a gas turbine 100, in accordance with an embodiment of the present invention. In an embodiment of the present invention, three primary algorithms, 310, 320, 330 may determine, in real time, the air-to-fuel ratio at the various modes of the start-up process. Next, algorithms 310,320,330 may determine the required fuel and air commands to be sent to the controllers of the IGVs 115 and the fuel system 125 allowing for optimization of the air-to-fuel ratio.

Block 310 illustrates the algorithm that may determine the air-to-fuel ratio. As discussed this algorithm may receive operating data 160 relating to: the physical properties of the air ingested by the compressor 110, the physical characteristics of the compressor 110, the physical properties of the fuel, and the physical characteristics of the fuel supply system 125, and the current operating parameters of the gas turbine 100. The physical properties of the air may include, but are not limited to: the temperature, pressure, the humidity, and other ambient conditions. The physical characteristics of the compressor 110 may provide data on the cleanliness and fouling of the compressor. These physical characteristics may include, but are not limited to, a flowrate, pressure, differential pressure, and the like. The physical properties of the fuel may include, but are not limited to, the heating value of the fuel, the specific gravity, temperature, Wobbie Index, and the like. The physical characteristics of the fuel supply system 125 may relate to the accuracy of the components of the fuel supply system 160. This data may include, but is not limited to, the difference between a valve reference and feedback, pressure, flowrate, and the like. The current operating parameters of the gas turbine 100 may include, but is not limited to, the speed and acceleration of the turbomachine. After receiving the data 160, the algorithm of block 310 may employ a look-up table, physics based model, or the like, to determine the air-to-fuel ratio, illustrated as arrow 315.

Fuel command block 320 functions to determine a fuel command 325 for a valve of the fuel supply system 125. Block 320 may incorporate an algorithm with a look-up table, physics based model, or the like, to determine the position command 325 after receiving the data of the air-to-fuel ratio 315.

Air command block 330 functions to determine an air command 335 for a valve of the IGVs 115. Block 320 may incorporate an algorithm with a look-up table, physics based model, or the like, to determine the position command 325 after receiving the data of the air-to-fuel ratio 315.

FIGS. 4A, 4B, collectively FIG. 4, are flowcharts illustrating a method 400 of starting a turbomachine, in accordance with an embodiment of the present invention. In an embodiment of the present invention, a graphical user interface (GUI) may be provide, allowing an operator to navigate the steps performed by the method 400.

In step 405, the method 400 the turbomachine may be started. Here, the operator of the turbomachine may have received a request for power

In step 410, the method 400 may prompt the operator, via the GUI to select a purge speed. An embodiment of the present invention may calculate the time required to complete a purge cycle at a given purge speed. Here, the method 400 may calculate the required purge time based on: the desired purge speed, current ambient conditions, and the size of the exhaust system. As discussed, selecting a higher purge speed may greatly reduce the startup time of the turbomachine.

In step 415, the method 400 may accelerate the turbomachine to the purge speed selected in step 410, starting the purge cycle. In an embodiment of the present invention, the method 400 may be integrated with the starting system used to start the turbomachine. Here, the starting system directly, or indirectly, accelerates the turbomachine to the selected purge speed.

In step 420, the method 400 may determine whether a purge cycle is complete. As discussed, the method 400 may calculate the time of the purge cycle. After this time is calculated, the method 400 may determine whether sufficient time has elapsed to complete the purge cycle. If the purge cycle is complete, then the method 400 may proceed to step 425, otherwise the method 400 may revert to step 415.

In step 425, the method 400 may determine the air-to-fuel ratio for the ignition process. As described, embodiments of the present invention may utilize an algorithm to calculate the air-to-fuel ratio required for the ignition process. For example, but not limiting of, the algorithm may perform the following steps. Receive data on the physical properties of air ingested by the compressor section. Receive data on a physical condition of the compressor section. Receive data on a physical property of a fuel delivered to the combustion system by the fuel system. Receive data on a condition of the fuel system. Then, the algorithm determines the air-to-fuel ratio for the ignition process. Embodiments of the method 400 may calculate the required air-to-fuel ratio for ignition at the selected purge speed. The method 400 may compensate for the present ambient and equipment conditions; and may allow the ignition process to occur at any speed.

In step 430, the method 400 may complete the ignition process. Here, for example, but not limiting of, the GUI may provide indication that the combustion system has flame in each combustion can of a gas turbine. As discussed, embodiments of the present invention may not require a warm-up cycle. This may reduced the overall start-up time of the turbomachine.

In step 440, the method 400 may determine an air-to-fuel ratio for the acceleration mode. As described, embodiments of the present invention may utilize an algorithm to calculate the air-to-fuel ratio required for the acceleration mode. For example, but not limiting of, the algorithm may perform the following steps. Receive data on the physical properties of air ingested by the compressor section. Receive data on a physical condition of the compressor section. Receive data on a physical property of a fuel delivered to the combustion system by the fuel system. Receive data on a condition of the fuel system. Then, the algorithm determines the required air-to-fuel ratio for the acceleration mode.

In step 445, the method 400 may utilize the aforementioned algorithm to continually determine the required air-to-fuel ratio as the turbomachine accelerates. Here, the method 400 incorporates a closed-loop controls philosophy to dynamically compensate for changes in ambient conditions, inlet conditions, and the like; as previously discussed.

In step 450, the method 400 may continue to actively determine the required air-to-fuel ratio until the turbomachine reaches a primary operating speed, such as, but not limiting of, FSNL. As with step 445, the method 400 incorporates a closed-loop controls philosophy to dynamically compensate for changes in ambient conditions, inlet conditions, and the like; as previously discussed.

As discussed, embodiments of the present invention may substantially reduce the time required to start a turbomachine. Embodiments of the present invention may significantly reduce the start-up time, because purging, ignition, and acceleration may all be accomplished at much higher speeds due to the real time calculation of the turbine systems air fuel ratio.

As one of ordinary skill in the art will appreciate, the many varying features and configurations described above in relation to the several exemplary embodiments may be further selectively applied to form the other possible embodiments of the present invention. Those in the art will further understand that all possible iterations of the present invention are not provided or discussed in detail, even though all combinations and possible embodiments embraced by the several claims below or otherwise are intended to be part of the instant application. In addition, from the above description of several exemplary embodiments of the invention, those skilled in the art will perceive improvements, changes, and modifications. Such improvements, changes, and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

What is claimed is:

1. A method of starting a turbomachine, the method comprising:
providing a turbomachine comprising: a compressor section, a fuel system, and a combustion system;
selecting a purge speed for the turbomachine; and
accelerating the turbomachine to the purge speed;
wherein the step of selecting the purge speed allows for reducing a start-up time of the turbomachine.

2. The method of claim 1 further comprising the step of determining whether a purge cycle is complete.

3. The method of claim 2 further comprising the step of determining an air-to-fuel ratio for an ignition process of the combustion system.

4. The method of claim 3, wherein the step of determining the air-to-fuel ratio of the ignition process comprises the steps of:
receiving data on an ambient condition of air ingested by the compressor section;
receiving data on a physical condition of the compressor section;
receiving data on a physical property of at least one fuel delivered to the combustion system by the fuel system;
receiving data on a condition of the fuel system; and
determining the air-to-fuel ratio for the ignition process of the combustion system.

5. The method of claim 4 further comprising the step of controlling a fuel flow of the fuel system to achieve the air-to-fuel ratio for the ignition process.

6. The method of claim of claim 5 further comprising the step of determining whether the ignition process is complete.

7. The method of claim 2 further comprising the step of selecting an acceleration rate for an acceleration process of the turbomachine.

8. The method of claim 7 further comprising the step of determining an air-to-fuel ratio for the acceleration rate of the turbomachine.

9. The method of claim 8, wherein the step of determining the air-to-fuel ratio for the acceleration process of the turbomachine comprises the steps of:
receiving data on an ambient condition of air ingested by the compressor section;
receiving data on a physical condition of the compressor section;
receiving data on a physical property of at least one fuel delivered to the combustion system by the fuel system;
receiving data on a condition of the fuel system; and
determining the air-to-fuel ratio for the acceleration process of the turbomachine.

10. The method of claim 9 further comprising the step of controlling a fuel flow of the fuel system to achieve the air-to-fuel ratio for the acceleration process to maintain the acceleration rate.

11. A method of starting a turbomachine, the method comprising:
providing a turbomachine comprising: a compressor section, a fuel system, and a combustion system;
selecting a purge speed for the turbomachine;
accelerating the turbomachine to the purge speed;
determining whether a purge cycle is complete; and
selecting an acceleration rate for an acceleration process of the turbomachine;
wherein the step of selecting the purge speed allows for reducing a start-up time of the turbomachine, increasing the possibility of the turbomachine meeting a requirement of a Fast Start operation.

12. The method of claim 11, determining an air-to-fuel ratio for an ignition process of the combustion system.

13. The method of claim of claim 12 further comprising the step of determining whether the ignition process is complete.

14. The method of claim 13 further comprising the step of determining an air-to-fuel ratio for the acceleration rate of the turbomachine.

15. The method of claim 14 further comprising the steps of controlling a fuel flow of the fuel system to achieve the air-to-fuel ratio for the acceleration process to maintain the acceleration rate; and accelerating the turbomachine to an operating speed at the acceleration rate.

16. A system configured for starting a turbomachine, the system comprising:
a turbomachine comprising: a compressor section, a fuel system, and a combustion system; and
a control system configured for controlling a starting process of the turbomachine, wherein the control system performs the steps of:
selecting a purge speed for the turbomachine;
accelerating the turbomachine to the purge speed;
determining an ignition air-to-fuel ratio for an ignition process associated with the combustion system;
utilizing the ignition air-to-fuel ratio while performing the ignition process;
selecting an acceleration rate for an acceleration process of the turbomachine;
determining an acceleration air-to-fuel ratio for the acceleration process of the turbomachine; and
utilizing the acceleration air-to-fuel ratio while accelerating the turbomachine to an operating speed.

17. The system of claim 16, wherein the control system determines the ignition air-to-fuel ratio by performing the steps of:
receiving data on an ambient condition of air ingested by the compressor section;
receiving data on a physical condition of the compressor section;
receiving data on a physical property of at least one fuel delivered to the combustion system by the fuel system;
receiving data on a condition of the fuel system; and
determining the air-to-fuel ratio for the ignition process.

18. The system of claim 16, wherein the control system performs the steps of:
receiving data on an ambient condition of air ingested by the compressor section;
receiving data on a physical condition of the compressor section;
receiving data on a physical property of at least one fuel delivered to the combustion system by the fuel system;
receiving data on a condition of the fuel system; and
determining the air-to-fuel ratio for the acceleration process.

19. The system of claim 16, wherein the fuel system comprises multiple fuel circuits.

20. The system of claim 19, wherein the multiple fuel circuits comprise at least one of: a gas fuel circuit, a liquid fuel circuit, or an IGCC circuit.
